(19) United States
(12) Patent Application Publication
(10) Pub. No.: US 2014/0236767 A1
(43) Pub. Date: Aug. 21, 2014

(54) MOBILE APPLICATION FOR IDENTIFYING AND PURCHASING GOODS AND SERVICES USING MOBILE DEVICE IN-BUILT CAMERA

(71) Applicants: SUMIT DUGGAL, New Delhi (IN); SAURABH DWIVEDI, San Francisco, CA (US)

(72) Inventors: SUMIT DUGGAL, New Delhi (IN); SAURABH DWIVEDI, San Francisco, CA (US)

(21) Appl. No.: 13/770,605

(22) Filed: Feb. 19, 2013

(51) Int. Cl. G06Q 20/32

(52) U.S. Cl. CPC G06Q 20/3223
USPC 705/26.61

(57) ABSTRACT

In one exemplary embodiment a computer-implemented method includes receiving a digital image of a matrix code. A user identifier associated with the digital image is received. The matrix code is identifying from the digital image. The matrix code can represent a good or a service, a price of the good or the service and/or a merchant identifier selling the good or the service. A fund is caused to be transferred from a user's account to a merchant's account. Optionally, the digital image of the matrix code can be captured by a digital camera in a mobile device of the user. The mobile device can include a user-side application that communicated the digital image and the user identifier. The fund can be obtained with a user's credit card number stored in a database.

### CROSS-REFERENCE TO RELATED APPLICATIONS

This application is a claims priority to U.S. patent provisional application No. 61/674,499 titled A MOBILE APPLICATION FOR IDENTIFYING AND PURCHASING GOODS AND SERVICES USING MOBILE DEVICE IN-BUILT CAMERA filed on Jul. 23, 2012 and 61/766,081 titled A MOBILE APPLICATION FOR IDENTIFYING AND PURCHASING GOODS AND SERVICES USING MOBILE DEVICE'S IN-BUILT CAMERA filed on Feb. 18, 2013. This provisional application is hereby incorporated by reference in its entirety.

### BACKGROUND

1. Field

This application relates generally to the field of mobile shopping systems. More particularly, the invention relates to the system where goods or services can be purchased using mobile device by scanning a matrix code such a QR (quick response) code.

2. Related Art

In today's world, with the advent of credit, debit, pre-paid, gift and other payment cards people have stopped using cash and checks as mode of making payments. However, to facilitate these transactions, people need to carry one of these payment cards. And as most of these payment cards have purchase limits, either enforced by the issuing bank or limited by the value of the card or money present in the individual's bank account, individuals carry more than one payment card to make purchases. In this age of technology when mobile phones are almost replacing computers, mobile phones can be used to make purchases, thereby reducing or eliminating the need to carry any type of payment card/plastic money. This becomes even easier as people are in reach of their mobile devices more than they are in reach of their payment cards.

### BRIEF SUMMARY OF THE INVENTION

In one exemplary embodiment, a computer-implemented method includes receiving a digital image of a matrix code. A user identifier associated with the digital image is received. The matrix code is identifying from the digital image. The matrix code can represent a good or a service, a price of the good or the service and/or a merchant identifier selling the good or the service. A fund is caused to be transferred from a user's account to a merchant's account.

Optionally, the digital image of the matrix code can be captured by a digital camera in a mobile device of the user. The mobile device can include a user-side application that communicated the digital image and the user identifier. The fund can be obtained with a user's credit card number stored in a database.

A method for conducting transactions using a mobile application, wherein said system comprises registering with a web-portal and providing the required details to secure database of said portal to avail the desired services, wherein said transactions comprise selling goods or services, purchasing goods or services or raising funds.

### BRIEF DESCRIPTION OF THE DRAWINGS

The present application can be best understood by reference to the following description taken in conjunction with the accompanying figures, in which like parts may he referred to by like numerals.

FIGS. 1A-B depict, in block diagram format, a process of identifying and purchasing goods and/or services using a mobile device's built-in camera, according to some embodiments.

FIG. 2 depicts, in block format, an example system for implementing process 100 and various use cases described herein, according to some embodiments.

FIG. 3 illustrates various types of input data from merchants and/or users to a QR code transaction manager, as well as, resulting example out data, according to some embodiments.

FIGS. 4A-F depict screen shots of various views of identifying and purchasing goods and/or services using a mobile device's built-in camera, according to some embodiments.

FIG. 5 depicts a computing system with a number of components that can be used to perform any of the processes described herein.

FIG. 6 depicts an exemplary computing system that can be configured to perform the processes provided herein.

FIG. 7 illustrates an example QR code transaction manger, according to some embodiments.

The Figures described above are a representative set, and are not an exhaustive with respect to embodying the invention.

### DETAILED DESCRIPTION

Disclosed are a system, method, and article of manufacture of identifying and purchasing goods and/or services using a mobile device's built-in camera. Although the present embodiments included have been described with reference to specific example embodiments, it can be evident that various modifications and changes may be made to these embodiments without departing from the broader spirit and scope of the particular example embodiment.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Exemplary Process

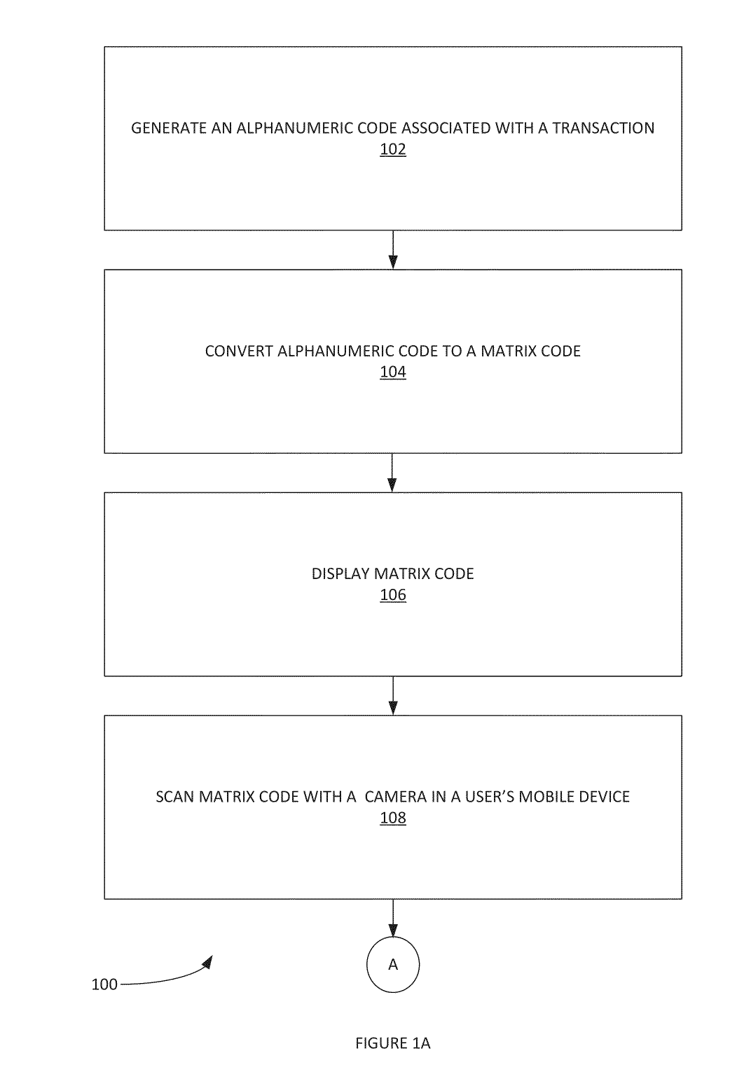

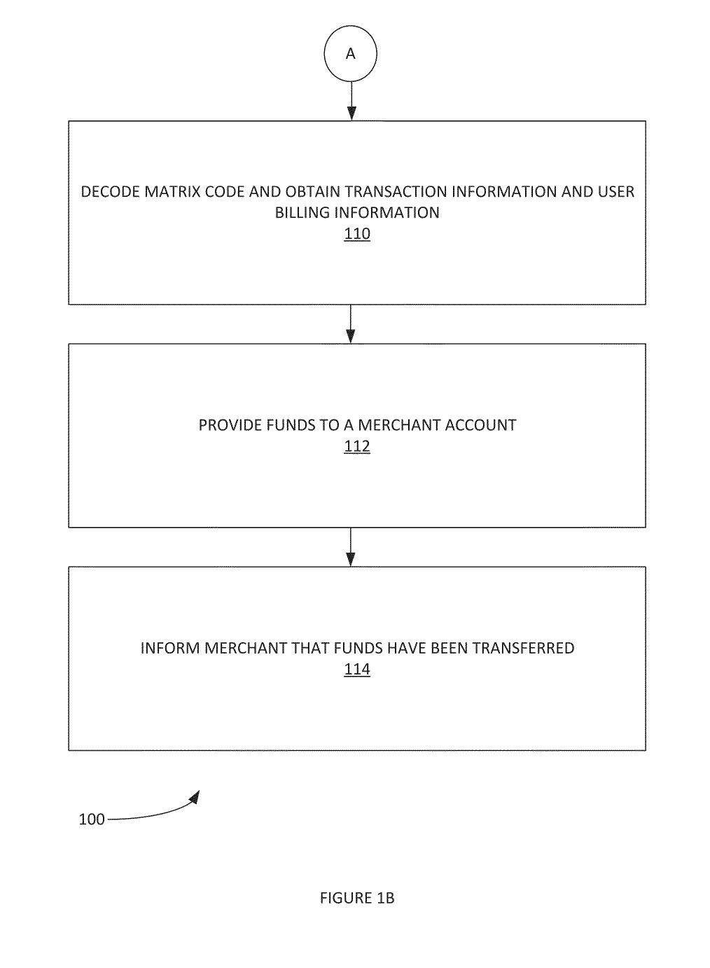

FIGS. 1A-B depict, in block diagram format, a process 100 of identifying and purchasing goods and/or services using a mobile device's built-in camera, according to some embodiments. As used herein, a mobile device can include a portable computer, typical with a display and a camera system (e.g. a smart phone, a tablet computer, wearable computers such as smart glasses or goggles, and the like). In step 102 of process 100, an alphanumeric code can be associated with a transaction. For example, a user (e.g. a customer) can request to purchase a good and/or service. A merchant can provide relevant information about the good and/or service (e.g. a merchant identifier, a transaction identifier, a transaction amount, etc.) to a code generation application implemented on a server via an application programming interface (API). The application can generate the alphanumeric code. Information about aspects of the transaction can be symbolized in the alphanumeric code. The alphanumeric code and relevant information can be stored in a database. As used herein, a transaction can include a sale of a good or service, a rental transaction, a loan transaction, a substitute for signing a document, signing into an event, registering for a course, etc. These examples are provided by way of illustration and not of limitation.

In step 104, the alphanumeric code is converted to a matrix code. In some embodiments, a matrix code can include a two-dimensional representation of information about the transaction (e.g. merchant information, good and/or service information, etc.). A matrix code can be optical machine-readable label. It can be physical (e.g. printed) and/or a virtual code rendered for display with a mobile device display, various multimedia (e.g. television, digital billboard), PC display, etc. In one example, the matrix code can be a custom quick-response code (QR code). A physical encoding of a QR code can be of any version of QR code (e.g. ISO/IEC 18004:2006, a NTT DoCoMo standard code, a custom code, etc.) in order to communicate information about the transaction. In one example, the QR code can represent a ten (10) digit alphanumeric code that represents/includes a merchant identifier, a merchant's bank account number, a transaction identifier and/or a transaction amount.

In other words, each element (e.g. product, good, service, etc.) can have an identifying number (e,g. an alphanumeric code that includes information). Each entity (e.g. merchant, purchaser, etc.) can have an identifying number. Identifying numbers can also be created for attributes of elements (e.g. cost, time, geolocation) and entities (e.g. selected purchase parameter, geolocation, billing address, and the like). The various identifying numbers associated with an entity and an element (e.g. a merchant and a product for sale) can be concatenated into a string of numbers. This string of numbers can be represented by a matrix code (e.g. as a QR code).

In step 106, the matrix code is displayed. For example, it can be physically printed and attached to a good. It can be physically printed on a bill and provided to a customer. It can be displayed during a television show or movie. It can be displayed with a merchant's application on a tablet computer. Other methods of displaying the matrix code can be utilized.

In step 108, a user can scan the matrix code with a camera in the user's mobile device. For example, the user can acquire a digital image and/or video of the matrix code. An application in user's mobile device can acquire the digital image from the camera's digital image store in the mobile device. The matrix code can be communicated by the user-side application to a server program (e.g. via the Internet or other digital computer network). The application can also include user information (e.g. user identification, user authentication data, user geo-location data and the like) to the server program. It is noted that the server-side program can be implemented in a cloud-computing environment as well. A user can capture an image of the matrix code and used the user-side application to perform a transaction e.g. purchase a good).

In step 110, the matrix code can be decoded. The transaction information can be identified. Other information, such as user-related data can be received as well. User-billing information can be determined. For example, a user can have previously registered with the service and one or more of the user's credit card numbers can be stored in the server-side aspects of the system implementing process 100. The data from the matrix code can identify relevant elements of the transaction such as merchant information, user (e.g. customer) information, authentication/security information, good and/or service information. The system can then bill the user's credit card (and/or other source of funds). The funds can then be provided to the merchant's account in step 112. In step 114, confirmation that the transaction has been completed can be communicated to the merchant (e.g. email, text message, a notification to the merchant-side application, etc.). Optionally, a receipt can also be sent to the user. The transaction can be considered complete. For example, a good may be considered purchased and the customer can then assert ownership thereof.

Exemplary Systems and Architecture

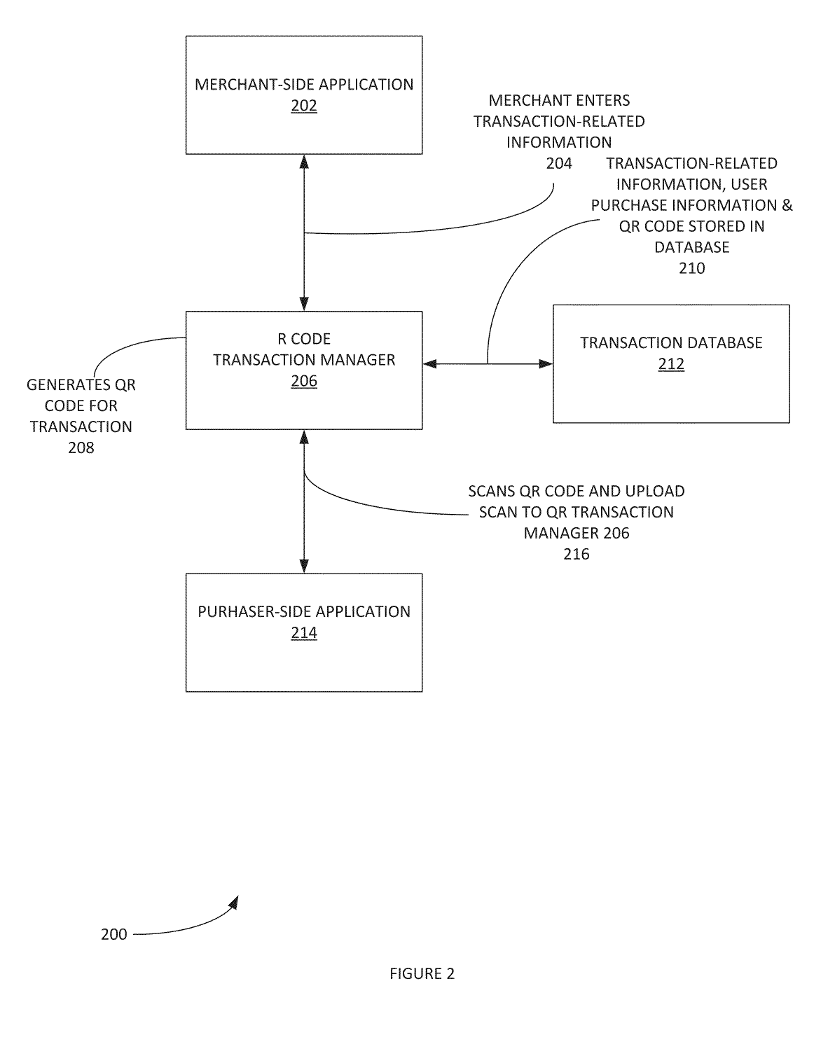

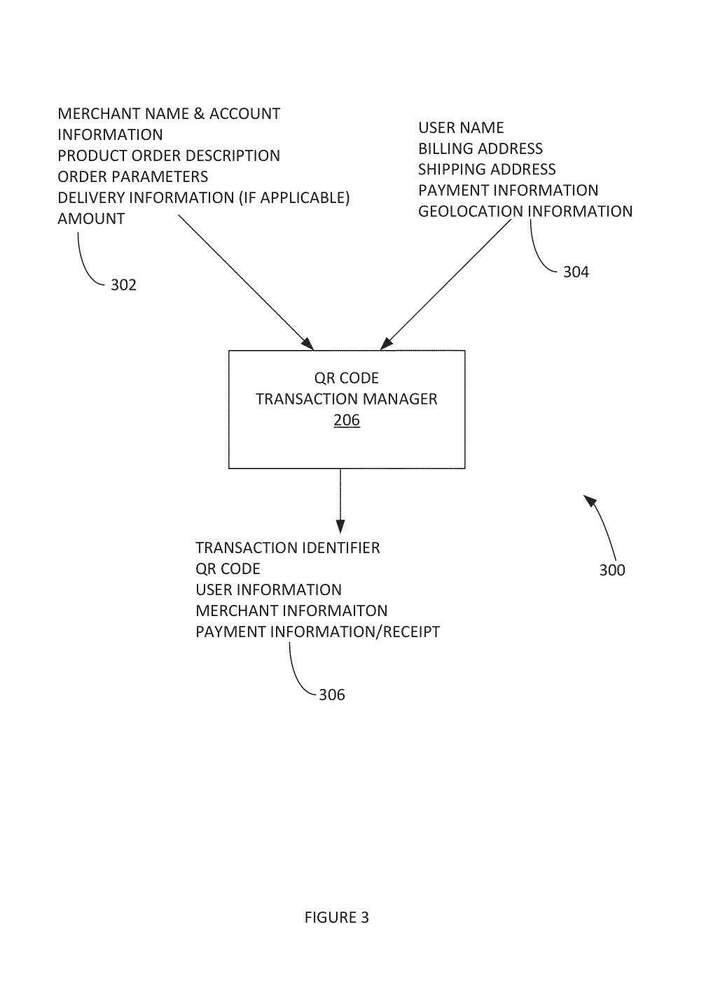

FIG. 2 depicts, in block format, an example system 200 and various steps for implementing process 100 and various use cases described herein, according to some embodiments. System 200 can include a merchant-side application 202. Merchant-side application 202 can provide an interface that allows merchants to upload merchant-related information and/or product information to QR code transaction manager 206. Various examples of merchant-related information and/or product information are provided in FIG. 3 infra. In particular, a merchant can upload transaction-related information in step 204 to QR code transaction manager 206. QR code transaction manager 206 can utilize this information to generate a QR code for the product and/or services associated with the transaction in step 208. In some embodiments, another form of matrix code can be utilized in lieu of a QR code and/or the QR code can be modified to include additional elements. In step 206, QR code transaction manager 206 can store data such as transaction-related information, user-purchase information, QR codes, and/or any other relevant type of data provided herein to transaction database 212. In step 216, purchaser-side application 214 scans QR code (e.g. using a camera) and uploads scanned QR code to QR code transaction manager 206. In this way, a user can utilize system 200 to purchase a good and/or service from a merchant.

Various example use cases and embodiments involving system 200 are now provided by way of example. In one embodiment, system 200 can generate a unique QR code for the users which is a kind of ‘SIGN’. The code can be embedded at the back-end (e.g. QR code transaction manager 206) with information such as merchant details, address, product description, product price, etc. (e.g. see inputs of FIG. 3 infra). System 200 can involve scanning the custom QR code using in-built cameras of mobile phones, such codes may be artistically made as a SIGN. System 200 can enable users to make credit card payments via mobile phone's camera without requiring any additional hardware installation, thus eliminating the need to carry cash or any credit or debit card swipes or any online or in-person transactions. In other words, system 200 can allow a user to purchase and/or shop for goods or services from a store, or other location by merely using his/her mobile phone. In order to sell the goods or services, a merchant is can to register with system 200 to generate the relevant QR codes for products, goods and/or services provided by the merchant.

The details of the user, such as credit card, debit card and/or bank account related information can be stored on a third party secure servers which are authorized to store such information. The user can add as many cards as per the choice. One of those cards can be kept as default and can be used if any other option is not selected. Each QR code can be generated by using system 200 and displayed to the user at the time of making a purchase. This code can be related to the back-end information details of the merchant and product(s). This code can be stored or generated in print form or in multimedia image form by merchant. For any purchase, the user can just scan this code using in-built mobile phone camera and carry out the purchase followed by money transaction.

Each merchant can generate the QR code using a web application provided by system 200 (e.g. can be managed by one or more web servers utilized by QR code transaction manager 206). These codes can include details such as purchaser's payment details, account information, address for shipment and/or estimated time required etc. Payment methods, such as those involving credit card, debit card or online transfer can be accomplished using this application without physically carrying any of these cards or cash.

A camera in a mobile device (e.g. a mobile phone) can enable a user to read and identify QR codes. This application can configured to be used across various mobile platforms (e.g. Android, IOS, Black Berry, Windows and the like). The display units of the mobile application can enable a user to read QR codes (e.g. translate and provide an augmented reality display element with information in human-readable format). The encoded QR codes can include information pertaining to the merchant, account information details, list of various products available with the merchant, product details and the method of delivery etc.

System 200 can include software used in combination with a computing device, such as a mobile device. The mobile device can be equipped with an in-built and/or attached camera. The display of the mobile can enable a user to see the product related information and associated costs instantly (e.g. utilized augmented reality elements that overlay a camera view of the product). However, the information about cards and other details of the user, which can be sensitive can be encoded and maintained with the user profile and stored in a secure web server. All the transactions carried out by users can maintained in transaction database 212. Optionally, at the time of each and every transaction, an instant notification can issue to the purchaser and/or the seller. System 200 can provide a platform for merchants to customize their sales interface to create a unique shopping experience for their customers.

In order to use the system, the users can download and launch purchaser-side application 214 into their mobile device. This is followed by entering the password in the application. Purchaser-side application 214 can be used to scan a QR code on a print and/or multimedia display. Purchaser-side application 214 can then display various product information, merchant information and/or an associated cost. Purchaser-side application 214 can retrieve this information from QR code transaction manager 206. In one example, purchaser-side application 214 can present various payment options and/or parameters to the user. For example, the user can click on ‘BUY’ to purchase the product. Purchaser-side application 214 can display the credit card related information and other transaction details and prompt for user to either ‘Confirm’ it or ‘Cancel’ it. On selecting ‘Confirm’, the transaction can be processed substantially instantly (assuming network and processing latencies) and payment shall be sent from user to the merchant's account through system 200. Further, an instant e-mail (or other messaging protocol such as text message, augmented-reality message, etc.) can be sent to both the purchaser and the merchant to notify them about the transaction.

System 200 can include various utilities in terms of safety, security and ease of use. In one embodiment, system 200 can enable contactless buying via print, multimedia, vending & point of sale verticals. Example applications include, inter alia: payment of utility bills (e.g. phone, electricity, gas, water etc.); buying of tickets for trains, movies through automated kiosks; substantially instant purchase of commodities (e.g. cold-drinks, snacks etc.) through automated vending machines; payment of bills at merchant point of sale terminals (e.g. Wal-Mart® and other big-box retailers; small to medium retails outlets etc.); direct purchase through print and multi-media display advertisements (e,g. ordering food, shoes, watch etc. directly from an advertisement; instant buying through telebrands etc.). System 200 can enable its user to buy products directly from a custom QR code stamped on any print or multimedia display advertising material. A merchant can customize product, price as well as the delivery information behind the QR code. This code can then be scanned by the user, using purchaser-side application 214, to buy these products, which can then be processed as an order and sent to the selling merchant for delivery. In order to use this application for the first time, a user can download it from Android®, iTunesCR) or Blackberry® application store. After this, the user can activate the application icon to sign-up and provide user profile and/or payment information. If the user is already signed-up, he/she can login with “username” and “password” (and/or other biometric authentication methods such as an iris and/or finger print scan). Once successfully logged in, the user can see a camera screen and a menu button. When the user scans a QR code/barcode with the camera screen, the application can show encoded information. In case the scanned code is stored in a server-side database (e.g. transaction database 212), the application can retrieve the encoded information and display that information on the mobile screen. The display information can consist of a seller merchant responsible for the product, product description, delivery terms, payment information etc. When the user decides to buy, he/she can click on the buy button. Once clicked, he/she can be asked to confirm the transaction. Once confirmed the user can get a confirmation message from system 200 followed by a confirmation email. QR code transactional manager 206 can include a module for generating and communicating messages to users and/or merchants. The confirmation email (or other message format) can be sent to the user as well as the merchant, and the transaction can appear in the transaction history of the purchaser and the merchant. When a user clicks on the menu button, he/she can took to a menu page full of icons with various functionalities, inter alia:

PROFILE—To edit/update password, addresses etc.

HISTORY—To access historical transactions by the user

PAYMENTS—To edit/update/delete payment information (Credit Cards, Bank Accounts etc.)

INVITE—To allow user to invite their friends and family members to download mobile application via email or mobile link

HELP—To access a helpdesk either by phone, email or instant message

UPDATE—To download a newer version of the application, if available

System 200 can also enable a merchant an option to accept a transaction (e.g. by responding to a pushed message to merchant-side application 202) before the transaction is completed.

In an example embodiment, a non-profit organization representative can follow the steps of: click on account in order to login and use it for any of the options, profile access, transactions, inbox, billing and campaign; select campaign button to add or start a new campaign, to add funds or to accept the donations already made; click on add/start a campaign button; type in the fundraiser description and the type of donation, he/she wishes to accept, the system provides two options i.e. suggestive or custom; chose the donation currency and option to apply to this particular fundraiser, optionally may also wish to set a time-period for the fundraiser; click Save and a new Custom Code is generated; download this custom code as PDF/PNG/JPEG in SMALL/MEDIUM/LARGE size; successful fundraiser campaign creation and logout from the system; paste/copy/print this custom code on all marketing and communication material related to this fundraiser.

In another example embodiment, a seller representative can follow the steps of: login the system; go to ‘my account’ section where following options can be accessed: profile, transactions, inbox, billing and products; click on the products tab to access all previous products and add a new product; click on the add product button; type in the following information: ‘product name and description’; ‘price and currency’, tax, shipping options/price (if any) and additional attributes (if any); click on save and a new custom code is generated; download this custom code as PDF/PNG/JPEG in SMALL/MEDIUM/LARGE size; successfully created a product and logout the system; paste/copy/print this custom code on all marketing and communication material related to this product.

In still yet another embodiment, a buyer can follow the steps of: open the application on your mobile; login to the system; scan the custom code of product/service which you wish to buy; click ‘buy’; confirmation screen will appear for the following: Total Transaction Amount, Merchant/Organization, Delivery address (if any) and Credit card details; then user will see a button titled ‘Confirm Transaction’; transaction goes the Authorize.net Payment gateway for approval/confirmation; once confirmed the user will get a confirmation screen on phone and email receipt and an SMS confirmation; the user can choose to go to the menu or exit the application and then logout. A QR custom code can be embedded with backend information about merchant or service provider including but not limited to company or organization details, address, price, bank account details. A user profile can include details like username, password, shipping address and credit and debit card details are maintained within the mobile application server.

FIG. 3 illustrates a system 300 that includes various types of input data from merchants and/or users to a QR code transaction manager, as well as, resulting example out data, according to some embodiments. A merchant information source can provide various types of information 302 to QR code transaction manager 206. A merchant can include any entity that offers goods and/or services for sate. Example merchant information 302 can include, inter alia: merchant name and account information, product order description, order parameters, delivery information, order amount etc. A user/customer source can provide various types of information 304 to QR code transaction manager 206. A user/customer can include any entity that purchases goods and/or services. Example user/customer information 304 can include, inter alia: user name, billing address, shipping address, payment information, geolocation information, etc. QR code transaction manager 206 can output various information 306. Information 306 can be provided to merchants and/or users according to the various examples provided herein. Example types of QR code transaction manager 206 outputs include, inter alia: transaction identifiers, QR codes, user information, merchant information, payment information, receipts, etc.

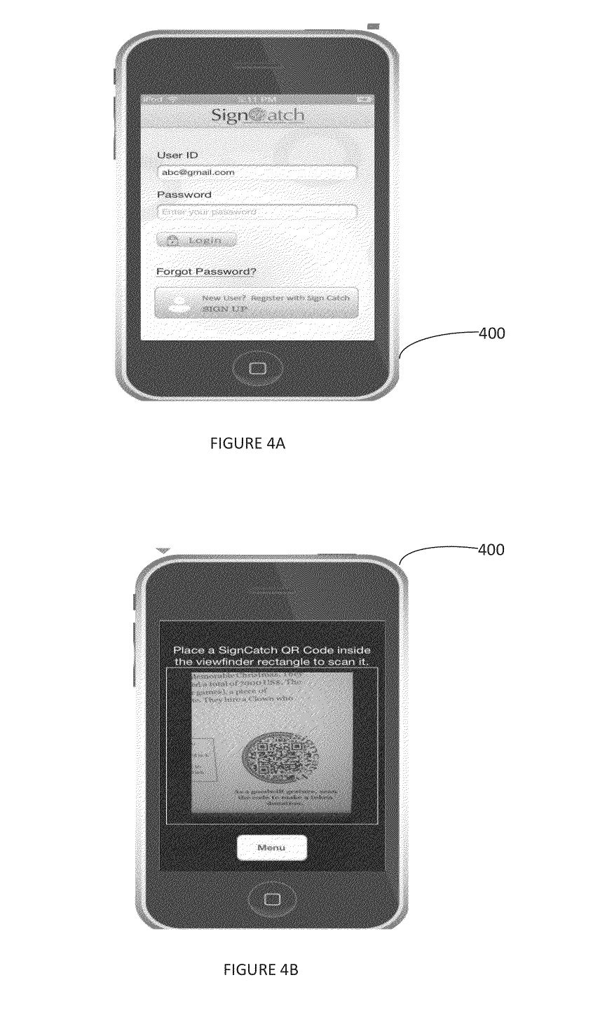

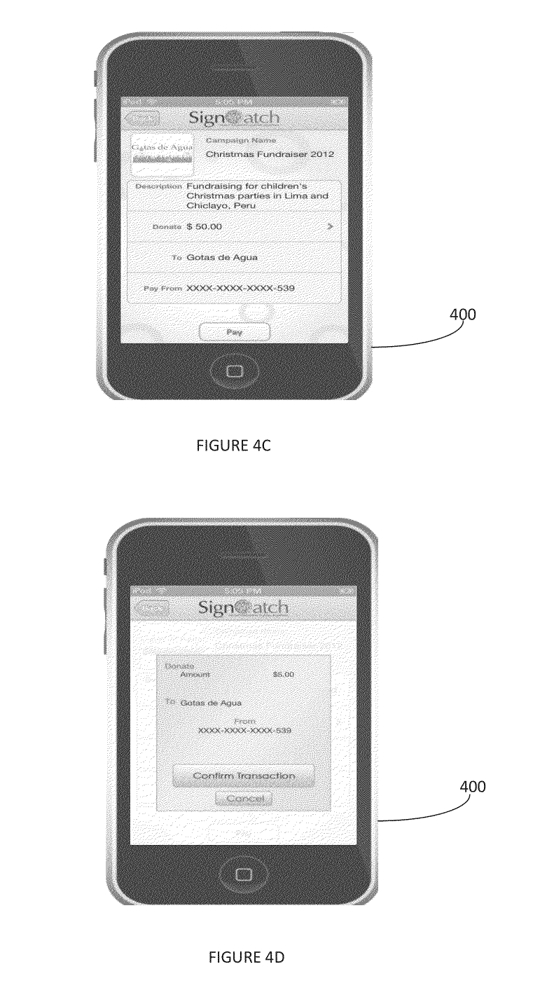

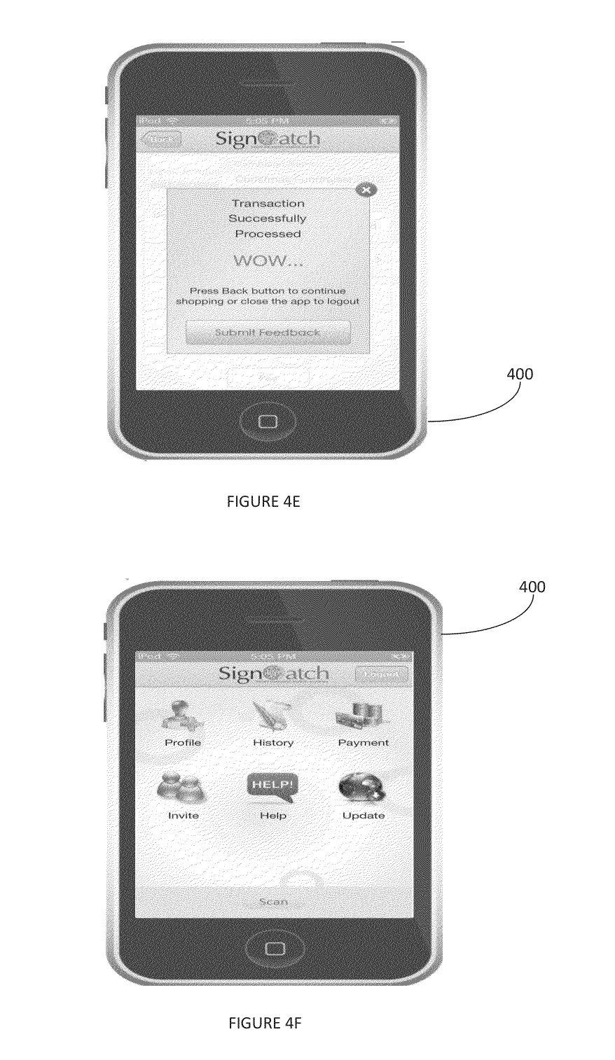

FIG. 4A-F depict screen shots of various views of identifying and purchasing goods and/or services using a mobile device's built-in camera, according to some embodiments. FIG. 4A depicts an example display of a user login and authentication page for purchaser-side application 214 on mobile device 400. Once a user has logged into purchaser-side application 214, the user can scan QR codes. FIG. 4B depicts an example view of a QR code being scanned with a camera in mobile device 400. The QR code can be obtained by purchaser-side application 214 and communicated to a remote server. FIG. 4C depicts an example view of a set of user options displayed by purchaser-side application 214. Purchaser-side application 214 can receive various information about user options that are specified for a product and/or service associated with the scanned QR code in FIG. 4B. FIG. 4D depicts a confirmation screen for the transaction depicted in FIG. 4C. FIG. 4E depicts a notification provided by QR code transaction manager 206 indicating that the transaction was successful. FIG. 4F depicts a set of user options provided by purchaser-side application 214.

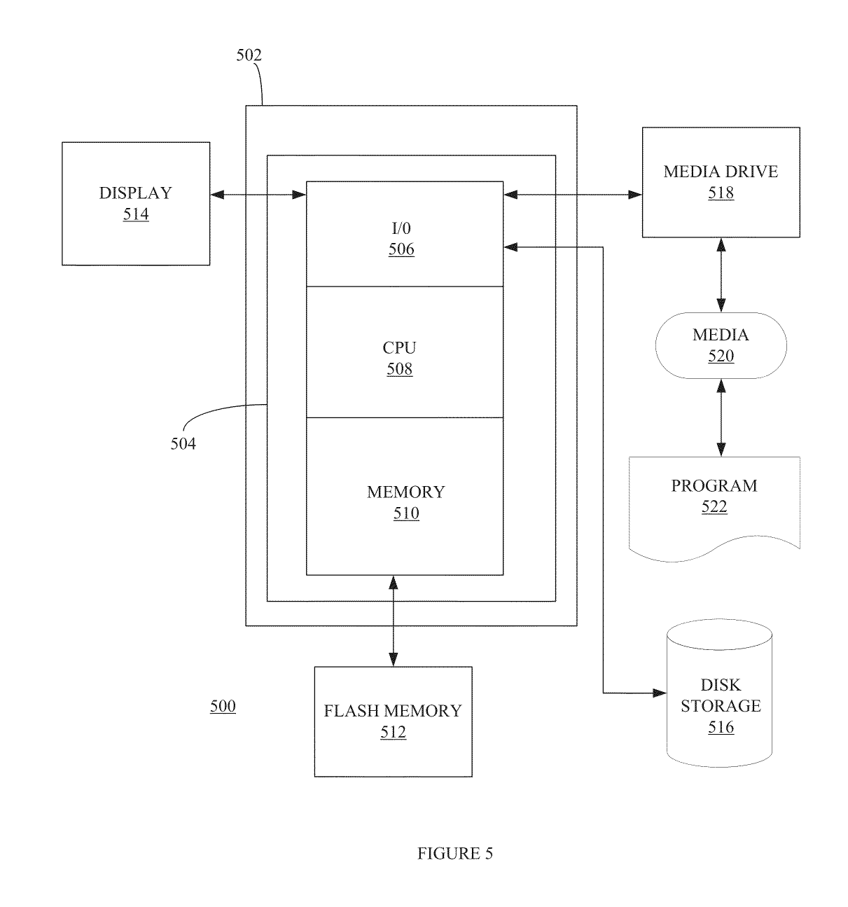

FIG. 5 depicts an exemplary computing system 500 that can be configured to perform several of the processes provided herein. In this context, computing system 500 can include, for example, a processor, memory, storage, and I/O devices (e.g., monitor, keyboard, disk drive, Internet connection, cloud, virtual, distributed network, data center, etc.). However, computing system 500 can include circuitry or other specialized hardware for carrying out some or all aspects of the processes. In some operational settings, computing system 500 can be configured as a system that includes one or more units, each of which is configured to carry out some aspects of the processes either in software, hardware, or some combination thereof.

FIG. 5 depicts a computing system 500 with a number of components that can be used to perform any of the processes described herein. The main system 502 includes a motherboard 504 having an I/O section 506, one or more central processing units (CPU) 508, and a memory section 510, which can have a flash memory card 512 related to it. The I/O section 506 can be connected to a display 514, a keyboard and/or other attendee input (not shown), a disk storage unit 516, and a media drive unit 518. The media drive unit 518 can read/write a computer-readable medium 520, which can include programs 522 and/or data. Computing system 500 can include a web browser. Moreover, it is noted that computing system 500 can be configured to include additional systems in order to fulfill various functionalities. Display 514 can include a touch-screen system. In some embodiments, system 500 can be included in and/or be utilized by the various systems and/or methods (e.g. process 100) described herein.

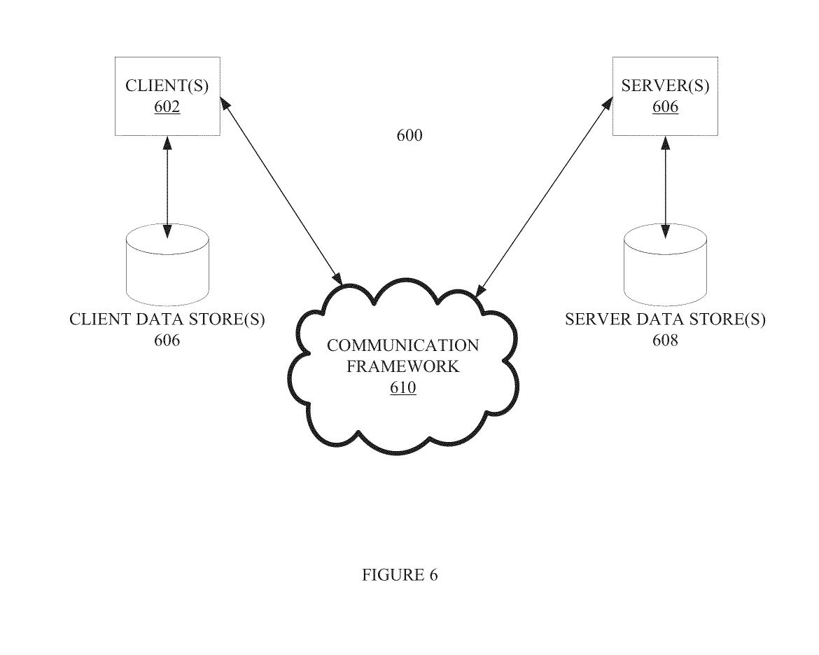

FIG. 6 is a block diagram of a sample computing environment 600 that can be utilized to implement some embodiments. The system 600 further illustrates a system that includes one or more client(s) 602. The client(s) 602 can be hardware and/or software (e.g., threads, processes, computing devices). The system 600 also includes one or more server(s) 604. The server(s) 604 can also be hardware and/or software (e.g., threads, processes, computing devices). One possible communication between a client 602 and a server 604 may be in the form of a data packet adapted to be transmitted between two or more computer processes. The system 600 includes a communication framework 610 that can be employed to facilitate communications between the client(s) 602 and the server(s) 604. The client(s) 602 are connected to one or more client data store(s) 606 that can be employed to store information local to the client(s) 602. Similarly, the server(s) 604 are connected to one or more server data store(s) 608 that can be employed to store information local to the server(s) 604. In some embodiments, system 500 and 600 can be included and/or be utilized by the various systems and/or methods described herein to implement processes described herein such as process 100, system 200, QR code transaction manger 700, as well as any other process as provided herein.

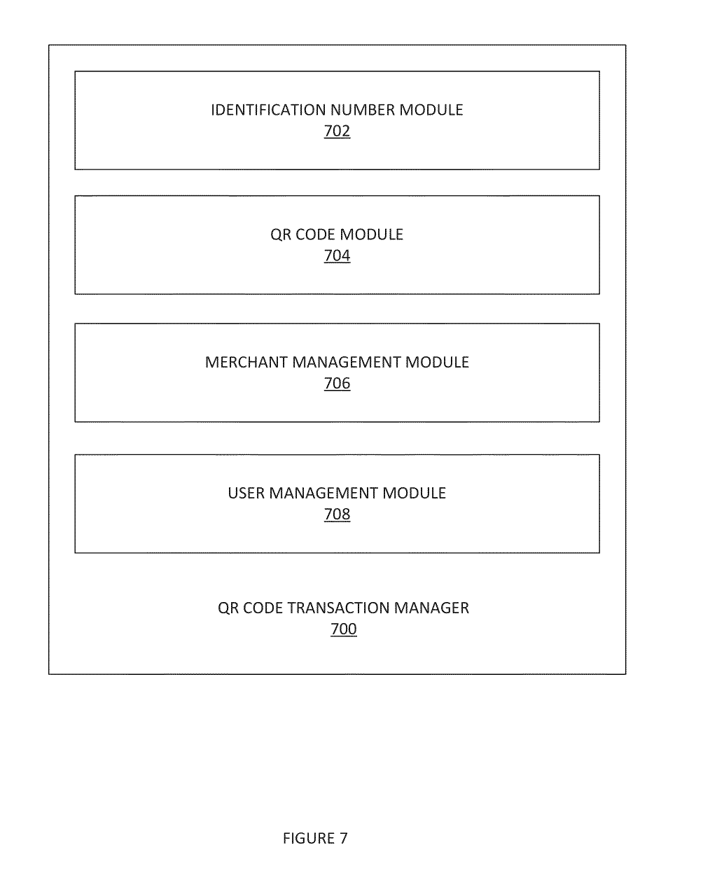

FIG. 7 illustrates an example QR code transaction manger 700, according to some embodiments. QR code transaction manger 700 can include an identification number module 702. Identification number module 702 can provide identifiers to various elements of a system for purchasing goods and/or services by scanning a QR code with a camera of a mobile device. For example, identification number module 702 can provide identifiers to merchants, merchant goods and/or services, users, time stamps of purchases, geolocation of merchants, goods and/or services and users, costs of goods and/or services, and the like. Identifiers can be alphanumeric. Identifiers can be unique and randomly generated (e.g. with a random number generator) and/or logically related to element identified (e.g. include human-readable identifying elements such partial spelling of a name of a merchant). Identification number module 702 generate indexes that associate identifiers with additional information (e.g. actual name, account information, etc.) about the identified element. QR code module 704 can convert identifiers to a matrix-bar code such as a QR code. QR code module 704 can also receive incoming scans of QR codes and identify the scanned element as well as additional information such as its cost, associated merchant, user that scanned image, etc. QR code module 704 can generate messages and/or augmented-reality elements to communicate to the merchant and/or user for display on their respective computing devices. These messages and include various information about the scanned product and/or service such as cost, geolocation, merchant identifiers, etc.

Merchant management module 706 can manage various merchant-related activities such as merchant registration, merchant inventory associated with at least one QR code, merchant transactions, merchant profiles, and the like. User management module 708 can manage various user-related activities such as user registration, merchant inventory associated with at least one QR code scanned by user, user transactions (e.g. transfer funds from a user's credit card to a merchant's bank account), user profiles, and the like. It is noted that QR code transaction manger 206 can be implemented using various aspects of QR code transaction manger 700 as well as other described supra. Additionally, it is noted, that QR code transaction manger 700 can include additional modules, not shown, to manage merchant/user registration, monetary fund transfers, system security, web servers, database servers, and the like.

At least some values based on the results of the above-described processes can be saved for subsequent use. Additionally, a (e.g. non-transients) computer-readable medium can be used to store (e.g., tangibly embody) one or more computer programs for performing any one of the above-described processes by means of a computer. The computer program may be written, for example, in a general-purpose programming language (e.g., Pascal, C, C++, Java, and Python) and/or some specialized application-specific language (PHP, Java Script, and XML).

### Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be preformed in any order (e.g., including using means for achieving the various operations). Accordingly, the specification and drawings are to be regarded in an illustrative rather than a restrictive sense. In some embodiments, the machine-readable medium can be a non-transitory form of machine-readable medium. Finally, acts in accordance with FIGS. 1-7 may be performed by a programmable control device executing instructions organized into one or more program modules. A programmable control device may be a single computer processor, a special purpose processor (e.g., a digital signal processor, “DSP”), a plurality of processors coupled by a communications link or a custom designed state machine. Custom designed state machines may be embodied in a hardware device such as an integrated circuit including, but not limited to, application specific integrated circuits (“ASICs”) or field programmable gate array (“FPGAs”). Storage devices suitable for tangibly embodying program instructions include, but are not limited to: magnetic disks (fixed, floppy, and removable) and tape; optical media such as CD-ROMs and digital video disks (“DVDs”); and semiconductor memory devices such as Electrically Programmable Read-Only Memory (“EPROM”), Electrically Erasable Programmable Read-Only Memory (“EEPROM”), Programmable Gate Arrays and flash devices.

What is claimed as new and desired to be protected by Letters Patent of the United States is:

1. A computer-implemented method comprising:
receiving a digital image of a matrix code;
receiving a user identifier associated with the digital image;
identifying from the digital image of the matrix code, by a processor, a good or a service, a price of the good or the service and a merchant identifier selling the good or the service; and
causing a fund to be transferred from a user's account to a merchant's account.

2. The computer-implemented method of claim 1, wherein the digital image of the matrix code is captured by a digital camera in a mobile device of the user,

3. The computer-implemented method of claim 2, wherein the mobile device include a user-side application that communicated the digital image and the user identifier.

4. The computer-implemented method of claim 1, wherein the fund is obtained with a user's credit card number stored in a database.

5. The computer-implemented method of claim 1, wherein the merchant's account is identified using the merchant identifier.

6. The computer-implemented method of claim 1, wherein the user's account is identified using the user identifier.

7. The computer-implemented method of claim 1, wherein the matrix code comprises a quick response code.

8. The computer-implemented method of claim 7, wherein the quick response code is generated from an alphanumeric identifier for the good or the service, the price of the good or the service and the merchant identifier selling the good or the service.

9. The computer implemented method of claim 8, wherein the quick response code comprises a two-dimensional bar code, and wherein the good or the service, the price of the good or the service and the merchant identifier selling the good or the service are embedded in the two-dimensional bar code.

10. A method for conducting transactions using a mobile application, wherein said method comprises registering with a web-portal and providing the required details to secure database of said portal to avail the desired services, wherein said transactions comprise selling goods or services, purchasing goods or services or raising funds.

11. The method as claimed in claim 10, wherein the said user can be a buyer, a seller or non-profit organization.

12. The method as claimed in claim 10, wherein in order to register with the said web-portal, each user provides a unique user ID, an e-mail address, and a password in order to generate an account with a system that implements the method of claim 10.

13. The method as claimed in claim 10, wherein once the account is created, the user is able to download the mobile application on a cell-phone.

14. The method as claimed in claim 10, wherein said custom code is embedded with backend information about merchant or service provider comprising company or organization details, address, price, or bank account details.

15. An apparatus for data analysis and use in a computing environment comprising:
a processor configured to execute instructions;
a memory containing instructions when executed on the processor, causes the receiving a digital image of a matrix code;
receiving a user identifier associated with the digital image;
identifying from the digital image of the matrix code, by a processor, a good or a service, a price of the good or the service and a merchant identifier selling the good or the service; and
causing a fund to be transferred from a user's account to a merchant's account.

16. The apparatus of claim 15, wherein the digital image of the matrix code is captured by a digital camera in a mobile device of the user.

17. The apparatus of claim 15, wherein the mobile device include a user-side application that communicated the digital image and the user identifier.

18. The apparatus of claim 15, wherein the find is obtained with a user's credit card number stored in a database.

19. The apparatus of claim 15, wherein the merchant's account is identified using the merchant identifier.

20. The apparatus of claim 15, wherein the matrix code comprises a quick response code, wherein the quick response code is generated from an alphanumeric identifier for the good or the service, the price of the good or the service and the merchant identifier selling the good or the service, and wherein the quick response code comprises a two-dimensional bar code, and wherein the good or the service, the price of the good or the service and the merchant identifier selling the good or the service are embedded in the two-dimensional bar code.
